(19) United States
(12) Patent Application Publication
(10) Pub. No.: US 2026/0019803 A1
(43) Pub. Date: Jan. 15, 2026

(54) Group Epoch Anonymization

(71) Applicant: Apple Inc., Cupertino, CA (US)

(72) Inventors: Jarkko L. Kneckt, Los Gatos, CA (US); Yanjun Sun, Cupertino, CA (US); Yong Liu, Campbell, CA (US); Elliot S. Briggs, Carmel, CA (US); Charles F. Dominguez, San Carlos, CA (US)

(21) Appl. No.: 19/204,146

(22) Filed: May 9, 2025

Related U.S. Application Data
(60) Provisional application No. 63/669,323, filed on Jul. 10, 2024.

(51) Int. Cl. H04W 12/02; H04W 84/12

(52) U.S. Cl. CPC H04W 12/02; H04W 84/12

(57) ABSTRACT

This disclosure relates to methods for configuring and using an epoch for anonymized communication in a wireless local area network. A wireless device may receive an indication that multiple group epochs are supported by an access point. The wireless device may provide an epoch request to the access point. The wireless device may receive epoch configuration information in response to the epoch request. The wireless device and the AP may perform communication with wireless device identification obfuscation using the epoch configuration information.

### PRIORITY INFORMATION

This application claims priority to U.S. provisional patent application Ser. No. 63/669,323, entitled “Group Epoch Anonymization,” filed Jul. 10, 2024, which is hereby incorporated by reference in its entirety as though fully and completely set forth herein.

### TECHNICAL FIELD

The present application relates to wireless communication, including techniques and devices for anonymizing wireless communications using group epoch operation.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. Security and privacy can be an important consideration for such communications. However, providing appropriate levels of privacy support for a variety of use cases, potentially including balancing complexity requirements, overhead, power consumption, and other considerations, can be a challenging problem. Accordingly, improvements in the field are desired.

### SUMMARY

Embodiments are presented herein of, inter alia, systems, apparatuses, and methods for devices to perform anonymized wireless communications using group epoch operation in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

According to the techniques described herein, a wireless device may request epoch setup for one or more wireless links, and may receive epoch configuration information for the wireless link(s). The wireless device may be able to obtain epoch discovery information that provides an indication of the types of epochs available, and to select a group or individual epoch that suits its current circumstances to request to join. The wireless device can then be provided with epoch parameters for operating according to the corresponding epoch. Such operation may include performing wireless communication on the configured link(s) with wireless device identification masking using the configured epoch parameters, and potentially periodically changing the obfuscation/masking parameters to accomplish an address change according to the epoch periodicity, which may help prevent tracking of the wireless device's identity and communications over time.

Techniques are also described for reducing or avoiding trackability of a wireless device across an address change due to possible frame retransmission using a different address than the original transmission. These techniques can include extending a transmit opportunity to retransmit a frame with address continuity across an address change, indicating successful reception of a failed frame to prevent retransmission with a different address after an address change, temporarily suspending new uplink transmissions in proximity to an address change to reduce the likelihood of needing to perform a retransmission after the address change, transmitting a block acknowledgement request frame in proximity to an address change to move a block acknowledgement window forward and discard any failed frames to prevent their retransmission after the address change, and/or creating one or more new frames for transmission after an address switch from failed frames from before the address switch, among various possibilities.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for configuring and using an epoch for anonymized communication in a wireless local area network, according to some embodiments;

FIGS. 6-7 illustrate some example aspects of possible group epoch operation, according to some embodiments;

FIG. 8 illustrates example aspects of a possible signal flow for performing default group epoch setup, according to some embodiments;

FIG. 9 illustrates example aspects of a possible enhanced privacy capabilities indication, according to some embodiments;

FIG. 10 illustrates example aspects of a possible signal flow for individual or non-default group epoch setup, according to some embodiments;

FIG. 11 illustrates an example set of epoch groups that could be operated by an access point, according to some embodiments;

FIG. 12 illustrates aspects of an example scenario in which address switches occur with and without retransmission across the address switches, according to some embodiments;

FIG. 13 illustrates aspects of an example scenario in which TXOP extension to avoid retransmission after an address switch could occur, according to some embodiments;

FIG. 14 illustrates aspects of an example scenario in which false acknowledgement to avoid retransmission after an address switch could occur, according to some embodiments;

FIG. 15 illustrates aspects of an example scenario in which temporary UL transmission suspension to avoid potential retransmission after an address switch could occur, according to some embodiments;

FIG. 16 illustrates aspects of an example scenario in which dozing extension to avoid potential retransmission after an address switch is performed, according to some embodiments;

FIG. 17 illustrates aspects of an example scenario in which a block acknowledgement request is used to avoid potential retransmission after an address switch is performed, according to some embodiments;

FIG. 18 illustrates aspects of an example scenario in which frame re-creation and new transmission is performed instead of retransmission after an address switch, according to some embodiments;

FIG. 19 illustrates aspects of an example scenario in which an access point provides downlink frames using both an old address and a new address across an address change during the same access point initiated transmit opportunity, according to some embodiments;

FIG. 20 illustrates aspects of an example scenario in which a wireless device provides separate uplink frames to an access point using an old address and then a new address across an address change during different wireless device initiated transmit opportunities;

FIGS. 21-22 illustrate aspects of example scenarios in which multi-user enhanced distributed channel access parameters are relaxed for retransmissions with old addresses during and/or within a certain time range of an address change, according to some embodiments;

FIG. 23 illustrates aspects of an example association identifier assignment space for an access point that includes a subset configured for obfuscating wireless device identification, according to some embodiments;

FIG. 24 illustrates aspects of an example scenario in which link specific anonymization timing is used during multi-link operation, according to some embodiments;

FIG. 25 illustrates aspects of an example scenario in which common multi-link device specific anonymization timing is used during multi-link operation, according to some embodiments;

FIG. 26 illustrates further aspects of a possible multi-link device level offset approach for multi-link epoch operation, according to some embodiments;

FIG. 27 illustrates further aspects of a possible link level offset approach for multi-link epoch operation, according to some embodiments;

FIG. 28 provides further possible details for a link specific anonymization approach for multi-link epoch operation, according to some embodiments;

FIG. 29 illustrates an example summary of possible link and multi-link device level offset applications in transmitter and receiver operations, according to some embodiments;

FIG. 30 illustrates aspects of an example wireless device with separate link specific group association identifiers and a multi-link device level association identifier for beacon operation, according to some embodiments;

FIG. 31 illustrates aspects of an example traffic indication map element format, in which traffic indication map offsets can be used, according to some embodiments; and

FIG. 32 is a table illustrating possible example traffic indication map association identifier handling aspects for various wireless device and frame types for an access point that supports anonymization using one or more group and/or individual epochs, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.11ay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

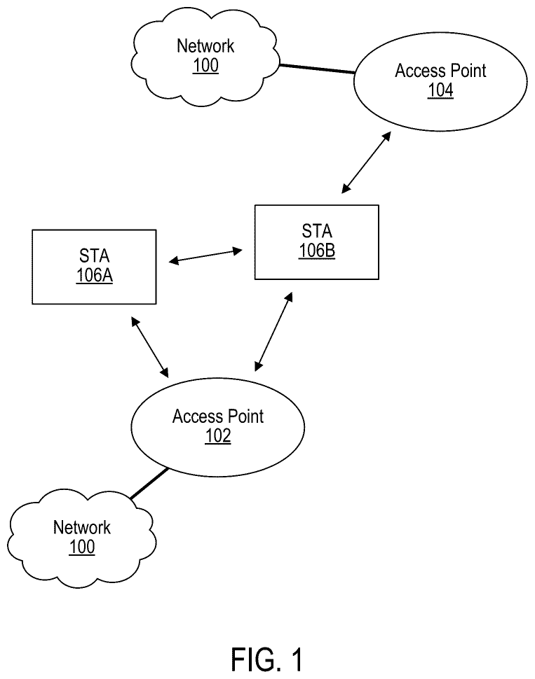

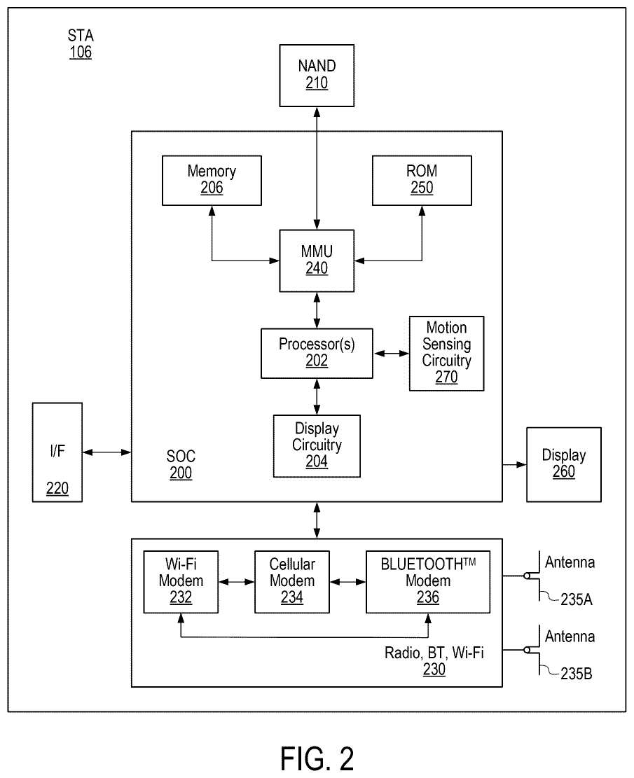

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service area (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to use an epoch for anonymized communication in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for configuring and using an epoch for anonymized communication described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

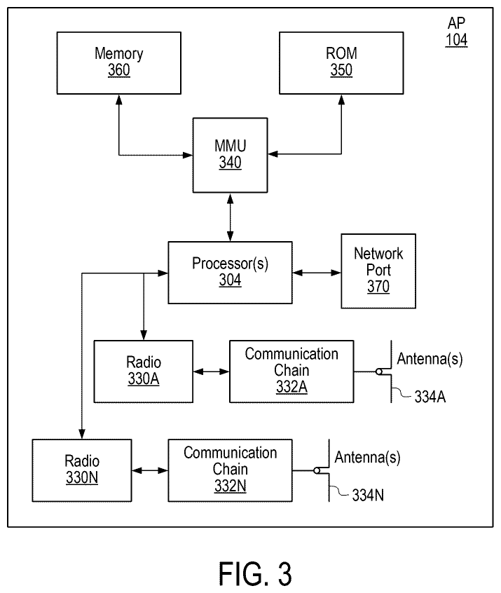

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as configuring and using an epoch for anonymized communication, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

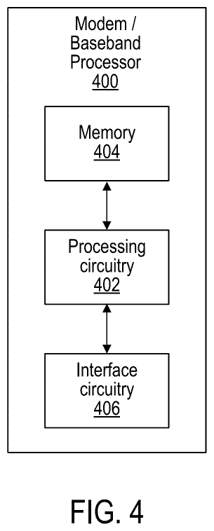

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as configuring and using an epoch for anonymized communication, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

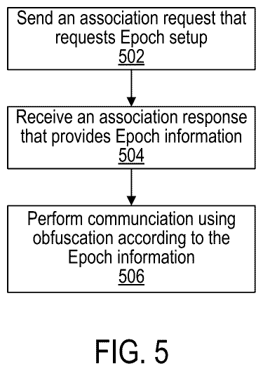

### FIG. 5—Epoch Operation for Anonymization

FIG. 5 is a flowchart diagram illustrating a method for supporting epoch operation to provide anonymization in a wireless communication system, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

At least two wireless devices may establish a wireless association. The wireless association may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. In some embodiments, an indication of whether support for group epochs (potentially including multiple group epochs) and/or individual epochs can be provided by an AP wireless device in a beacon transmission. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

A wireless device may perform a data transmission to another wireless device with which it has formed an association. According to various embodiments, the data transmission can be initiated by the wireless device by contending for medium access (e.g., to avoid collisions and potential interference), or by receiving a transmit opportunity grant from another wireless device (e.g., the device with which it has formed an association) that has already contended for and obtained medium access, among other possibilities. Once medium access is obtained, the wireless device can transmit a physical layer (PHY) protocol data unit (PPDU) (which may also be referred to as a data frame) to the destination wireless device. The data frame can include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs).

A wireless device (e.g., a non-AP STA) can send an association request to another wireless device (e.g., an AP STA), e.g., as part of establishing the initial association between the wireless devices (502). In some embodiments, the association request can be a re-association request, e.g., if the non-AP STA is already associated to the AP STA or another AP STA in a wireless communication system with shared security features, for example using over-the-air (OTA) fast transition (FT) signaling. The association request may indicate that epoch setup is requested, e.g., based at least in part on beacon information indicating that group and/or individual epoch support is available from the non-AP STA. For example, the association request may include a request for individual epoch setup or default or non-default group epoch setup. In some embodiments, the epoch setup request included in the association request may not specify a type of epoch setup requested; for example, initial epoch setup may be performed only for a default group epoch, and it can be the case that requests for individual or non-default group epoch setup are supported after association signaling is complete.

The AP STA may provide an association (or re-association) response to the non-AP STA that includes epoch configuration information (504). For example, the epoch configuration information could include epoch parameters such as a basic service set (BSS) specific offset, a STA specific offset, address switch timing information, and/or any of various other parameters associated with epoch operation for an epoch to which the non-AP STA is assigned. At least in some instances, the epoch configuration information included with an association response may be default group epoch configuration. For example, the epoch request may have been a default group epoch setup request. Alternatively, the epoch request may have been a non-default group epoch setup request or an individual epoch setup request, but the non-AP STA may still initially be assigned to the default group epoch, and setup for non-default group epochs and individual epochs may be performed after association (or re-association) is complete.

In some embodiments, the BSS specific offset may be used to obfuscate or mask the association identifier (AID) of the non-AP STA during OTA transmission, e.g., to provide a greater degree of anonymity to the non-AP STA. The STA specific offset may be used to obfuscate or mask one or more other elements of OTA transmissions to and/or from the non-AP STA, such as the traffic identifier (TID), sequence number (SN), and packet number (PN) media access control (MAC) header fields, among other possibilities. The address switch timing information may indicate how often the offset information is changed for a given epoch; such address switches may help further impede possible tracking and improve anonymization effectiveness of the epoch operation, at least according to some embodiments. In some instances, epoch configuration information for some or all epochs may additionally include traffic indication map (TIM) offset information, which can be used to mask STA AID specifically for the TIM element of beacon transmissions by the AP STA, and which can be different than a BSS specific offset used to mask the STA AID for uplink and/or downlink frame transmissions. Such information can be changed using the same timing as other epoch parameters (e.g., at group epoch anonymization times) and/or at beacon intervals, according to some embodiments.

The non-AP STA and the AP STA may perform wireless communication (e.g., including downlink and/or uplink data frame transmission) with wireless device identification obfuscation using the epoch configuration information (506). This may include masking the AID using the configured BSS specific offset, masking potentially identifying MAC header elements using the STA specific offset, and/or otherwise making use of any the epoch configuration parameters to anonymize the frames transmitted. At configured address switching times, the non-AP STA and the AP STA may rotate the offsets used, e.g., based on signaling or in a pre-configured way. It may be the case that a non-AP STA receives with both the old and new addresses for a brief period of time surrounding the address change time, e.g., in case of possible clock drift.

As previously noted, in some embodiments, setup for non-default group epochs and/or individual epochs may be performed after association (or re-association) is complete. For example, in some embodiments, the AP STA may provide solicited (e.g., in response to a request for such information from the non-AP STA) or unsolicited epoch discovery information to the non-AP STA, which may indicate parameters of available group epochs, e.g., in a group epoch information frame. The different group epochs available could include group epochs with different epoch period length (address change timing/anonymization periodicity), different degrees of wireless device identity obfuscation (e.g., more or fewer offset parameters, and/or application of such parameters to mask more or fewer elements of frames transmitted OTA), and/or could differ in any of various other possible ways, for example to cater to different device types, applications, network types, end user preferences, internet browsing modes, etc.

As one possible example set of epoch groups, it could be possible to provide a “slow” group epoch, a default group epoch, and a “fast” group epoch. The slow group epoch can have less frequent address changes compared to the default group epoch, and/or automatic parameter updates, e.g., to potentially reduce power consumption requirements. In some embodiments, devices operating in such a group epoch may be configured to operate only on single user transmissions, such that the AID need not be used in uplink or downlink transmissions. The fast group epoch can have more frequent address changes compared to the default group epoch, and/or can potentially anonymize more frame elements (e.g., More Data, EOSP, Power Management, and HT Control fields, as one possibility) than the default group epoch, e.g., to provide an even greater degree of anonymization.

Once group epoch information is available, the non-AP STA may be able to transmit an epoch setup request to the AP STA to request to join one of the advertised group epochs. As another possibility, the non-AP STA may be able to transmit an epoch setup request to the AP STA to request to join an individual epoch. The AP STA may provide an epoch setup response to provide epoch configuration parameters for the requested group or individual epoch. In some embodiments, a created individual epoch may be made available to other devices as well, in which case the AP STA may signal this as a new group epoch. Note that, at least in some embodiments, it may be the case that a STA can operate only in a single epoch at a time; the STA may, however, be able to change the epoch according to which it operates, e.g., depending on any of a variety of possible considerations.

It may be possible that the AP STA and the non-AP STA can operate as multi-link devices (MLDs), e.g., with multiple wireless links established. For example, the AP STA may be capable of providing a BSS on each of multiple links, such as on a 2.4 GHz link, a 5 GHz link, and/or a 6GHz link. The AP STA may operate in a standalone manner or may be affiliated with one or more other devices, e.g., as part of a larger network. For example, the AP STA could be a member of a multi-access point (MAP) system, which could include multiple AP STAs, in some embodiments. Similarly, the non-AP STA may be capable of operating on each of those multiple links.

In such scenarios, multi-link group epoch operation may be used. In some embodiments, this may include each link's anonymization working independently and at its own time; for example, per-wireless link offset information and per-wireless link offset change timing information can be used for the multiple wireless links. Alternatively, one or both of offset configuration or anonymization timing could be handled at the MLD level; for example, per-wireless link offset information and MLD level offset change timing information can be used for the multiple wireless links, or MLD level offset information and MLD level offset change timing information can be used for the multiple wireless links. It may also be possible for MLD level offset information and per-wireless link offset change timing information to be used for the multiple wireless links, but it should be noted that this approach may be more trackable than other combinations of MLD and link-level configuration for multiple wireless links, e.g., since the links may change to the same offset at different times in this approach, at least according to some embodiments.

In some embodiments, it may be useful to implement one or more techniques for mitigating possible wireless device trackability across an address change for an epoch due to retransmissions. For example, it could be the case that a transmitter encrypts the payload data of an MPDU only once, such that the encrypted data payload does not change if the STA MAC address in the MAC header changes, which can potentially allow eavesdroppers to monitor the MPDU payloads to detect whether the same data payload is transmitted from a new address. In some embodiments, mitigation techniques for this may be considered unnecessary, as retransmissions may generally not occur across every address change, so as long as address changes are sufficiently frequent, at least some address changes may successfully block possible address tracking across the address change. As another possibility, a non-AP STA and AP STA may agree on a maximum number of consecutive address switches with retransmitted data payload that is initially transmitted using an old address, and such retransmissions may not be performed when the agreed upon maximum number is reached.

As another possible technique, it may be the case that some TXOP extension or expansion (e.g., using TXOP bursting) is allowed to retransmit one or more failed frames using the old address after an address change time. Thus, in some embodiments, the non-AP STA or the AP STA could extend a TXOP after a TXOP limit to retransmit a frame with address continuity during an address switch window for the epoch of the non-AP STA. The amount of time for which such a TXOP can be extended may be configured to be limited in one or more ways; for example, such TXOP extension could be configured to be allowed to continue until all frames are successfully received (acknowledged), or the retransmitted frames are discarded (maximum retransmissions reached), or until a configured maximum TXOP continuation time has elapsed.

Still another possible technique could include a downlink MPDU retransmission avoidance scheme, in which the non-AP STA can transmit a frame acknowledgement (e.g., indicating successful reception) for a frame that was not successfully received based at least in part on address switch window timing for the epoch for the non-AP STA, e.g., to prevent the AP STA from attempting retransmission of the failed frame using the new address after the address switch. Such an approach may be useable for some stream or real-time applications that can tolerate some frame loss, at least as one possibility.

Techniques for uplink MPDU retransmission avoidance are also possible. One such technique could include temporarily suspending uplink frame transmission based at least in part on address switch window timing for the epoch for the non-AP STA. For example, the non-AP STA may avoid new uplink transmissions for a certain time period leading up to an address switch, to reduce the likelihood that uplink retransmissions across the address change could occur. As a related possibility, if new data arrives when the non-AP STA is in a doze (power save) state within a certain time window of an address switch, the STA may wait to wake until it can use the new address, e.g., to reduce power consumption. Such an approach may be usable for some best effort and background data use cases that do not have strict real time requirements, at least as one possibility. Similarly, in some cases, the non-AP STA could signal to the AP that it is unavailable or in power save for a period of time before the address switch time to avoid situations in which the AP STA would have frames that need to be retransmitted to the STA.

A further possible technique could include discarding uplink frames using a block acknowledgement request (BAR) to avoid retransmission across an address change. For example, the non-AP STA could transmit a BAR frame to move a BA window forward based at least in part on address switch window timing for the epoch of the non-AP STA. The non-AP STA may correspondingly discard any failed frames from the previous BA window, which may prevent retransmission with the new address. In some instances, the BAR frame may be transmitted as the last frame of the TXOP that uses the old address, e.g., to avoid possible tracking across the address change from transmitting a BAR in the first TXOP with the new address.

In some embodiments, the non-AP STA can create one or more new MPDUs out of one or more failed MPDUs rather than retransmitting the failed MPDUs in a way that could compromise the anonymization of an address change. For example, the non-AP STA could create one or more new frames for transmission after an address switch for the epoch for the non-AP STA using one or more failed frames from before the address switch. The failed frames can be created as new frames with higher SN values. Since the end receiver receives all frames, this scheme may avoid frame loss; the transmitted application may have headers that allow the end receiver to arrange the frames in playout order. In some embodiments, the payload of the MPDU may be changed to avoid duplicate payload detection by a potential eavesdropper; for example, the DSCP value of the IP packet could be changed before encryption, as one possibility. For downlink transmissions, it can also be possible for the AP STA and the non-AP STA to agree that new MPDUs can be created from potentially retransmitted MPDUs after an address change for certain QoS levels (e.g., specific user priority (UP) or TID values). If such an agreement is made, it may be the case that the AP STA makes a new MPDU from any downlink frame in such a UP or TID that needs retransmission after an address change.

In some embodiments, it may be possible that different rules for use of the old and new address for UL and DL TXOPs are configured. For example, it can be the case that UL enhanced distributed channel access (EDCA) TXOPs are allowed to transmit UL frames only from a single address. This may be enforced as using two addresses (e.g., old and new) in the same TXOP could reveal a wireless device. For DL TXOPs, it may be allowed to transmit traffic to multiple STAs, and as such it may potentially be possible for an AP to transmit traffic to the same STA at both its old and new address in the same TXOP. It may be the case that the AP does not transmit such traffic simultaneously to the old and new address of the same STA, e.g., as the STA may not be able to receive both such transmissions. It may be the case that if both AP and non-AP STA addresses are anonymized in an address change, a TXOP is used to transmit frames only to a single receiver in UL and DL, in some embodiments.

In some embodiments, an AP STA may use multi-user (MU) EDCA parameters to reduce EDCA transmissions from the STAs from which UL transmissions can be triggered. A trigger frame can identify a STA using its AID, and the old and new address for a STA may use different AIDs across an address switch. A STA may accordingly determine and/or be configured to only transmit MPDUs with a single address as a response to a trigger frame. For example, in some embodiments, to facilitate UL retransmission of data using an old address, the AP may signal (e.g., in protected (re-)association response) that the AP may not trigger STA frames from the old address after an address change. In these cases, the STA may be allowed to retransmit the old addressed MPDUs using EDCA channel access parameters and may be allowed to ignore the MU EDCA parameters for these frames.

Thus, according to the method of FIG. 5, it can be possible to perform epoch based anonymized communication between wireless devices, including using techniques for operating multiple group epochs, individual epochs, and/or multi-link epochs, as well as various techniques for avoiding trackability across an address change due to frame retransmissions, at least according to some embodiments.

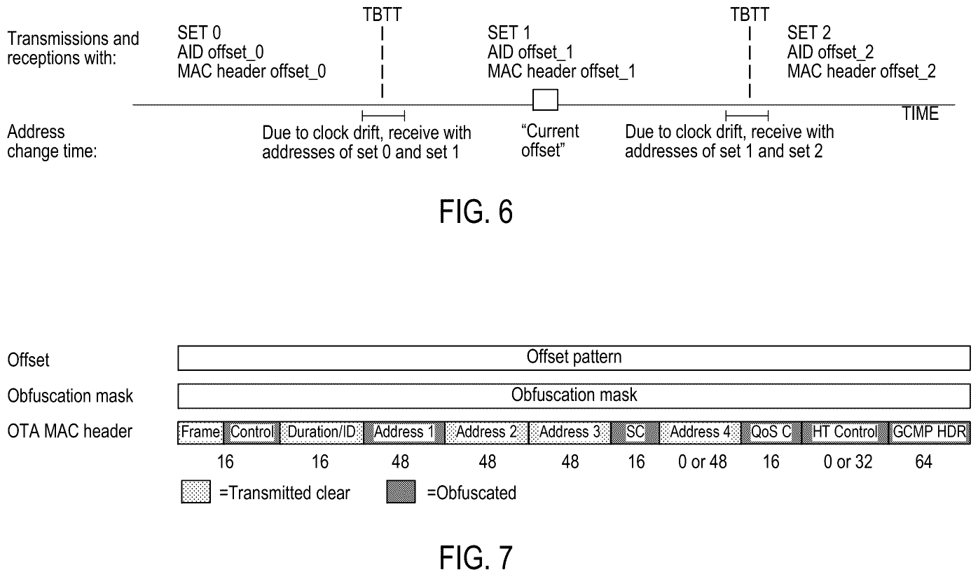

### FIGS. 6-32 and Additional Information

FIGS. 6-32 illustrate further aspects that might be used in conjunction with the method of FIG. 5. It should be noted, however, that the exemplary details illustrated in, and described with respect to, FIGS. 6-32 are not intended to be limiting to the disclosure as a whole: numerous variations and alternatives to the details provided herein below are possible and should be considered within the scope of the disclosure.

Group Epoch operation can be used to provide anonymization/obfuscation for wireless devices in a wireless communication system, such as a Wi-Fi based communication system. FIGS. 6-7 illustrate some example aspects of such group epoch operation. As shown, basic timing for group epochs can be in multiples of target beacon transmission time (TBTT) intervals. Association identifier (AID) anonymization is achieved using a BSS specific offset, and individual media access control (MAC) header anonymization with STA specific offset. A mask is applied to determine offset bits. One time calculation of all BSS specific offsets and STA specific offset can be performed for use for the group epoch operation, in some instances. One set can include STA address offset, sequence number (SN) offset, and packet number (PN) offset, and during address change times, it can be the case that a wireless device receives using both pre- and post-address change addresses for a certain (e.g., specified, configured, or individually determined, as various possibilities) period of time around the address change, e.g., due to possible clock drift.

It may be possible for an AP to operate multiple group epochs, at least according to some embodiments described herein. To support such operation, features may be provided for association and selecting to operate on a default group epoch, as well as for discovery of the available group epochs in an AP, which could include unicast discovery request/response exchange, and unicast setup of a non-default group epoch or an individual epoch.

Features are also described herein for mitigating possible address change vulnerabilities. Such features can include techniques for avoiding retransmissions after an address change, and/or potentially tolerating some data payload retransmissions by using the new addresses. Possible rules for uplink and downlink transmit opportunity (TXOP) content and triggered access are also described herein. Further, techniques for anonymizing the traffic indication map (TIM) for a beacon are described herein, which can potentially protect AID values of STAs and make STA tracking more difficult, while keeping reduced overhead in beacon frames.

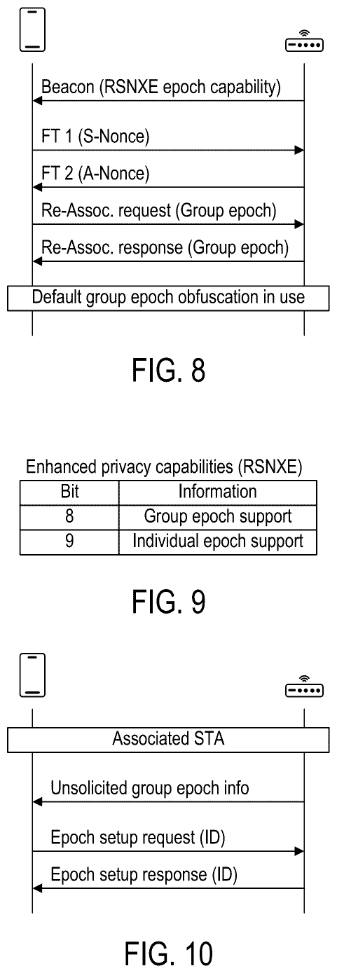

FIG. 8 illustrates example aspects of a possible signal flow for performing default group epoch setup, according to some embodiments. In the example scenario, an AP signals support for group epochs and individual epochs in beacon and probe response frames. For example, an enhanced privacy capabilities (RSNXE) indication such as illustrated in FIG. 9 can be used to signal group epoch support and/or individual epoch support. Over-the-air fast transition (OTA-FT) signaling can include a nonce exchange to establish security. The STA can then send a protected (re)association request with an indication that group or individual epoch operation is requested. The group epoch request can be a 1 bit indicator to request that the STA be assigned to the default group epoch. The individual epoch request can be a 1 bit indicator to request that the STA be set up for individual epoch operation after association. The AP can send a protected (re)association response. If group epoch operation was requested by the STA, the AP can provide default group epoch parameters to the STA. If individual epoch operation was requested, the group or individual epoch setup can be done after association.

FIG. 10 illustrates example aspects of a possible signal flow for such individual or non-default group epoch setup, e.g., which could be performed after the default group epoch setup signal flow of FIG. 9, according to some embodiments. An associated STA may be able to discover all available group epochs. The STA may request parameters of available group epochs. The AP can transmit a solicited or unsolicited group epoch information frame including epoch information for the AP. Note that at least in some embodiments, it may be the case that broadcast group advertisements are not provided, for example because it may be the case that broadcasted group frames are not encrypted (e.g., they may only be integrity protected). The STA can send epoch modification requests to setup individual epochs or to join any group epoch. For an individual epoch, a one time scheduled address and AID change can be used, in some embodiments. The created individual epoch can be available for other devices too; for example, the AP may signal this time instance as a new group epoch. Note that in some instances, it can be the case that a STA may operate only in a single epoch at a time. The STA may be able to change the epoch that it operates according to depending on the application, network type, end user preferences, incognito or private internet browsing mode, and/or any of various other possible considerations.

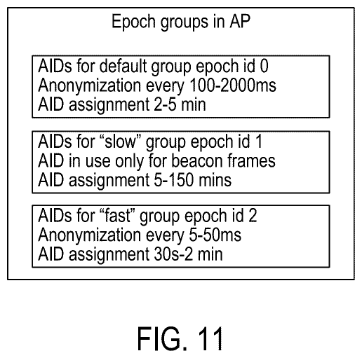

FIG. 11 illustrates an example set of epoch groups that could be operated by an AP, according to some embodiments. In the illustrated example, three epoch groups are operated. The AlDs of a group epoch are obfuscated at the group specific time. Groups with different epoch durations can have different AID ranges, e.g., to avoid AID collisions.

One of the epoch groups in the illustrated example is a “slow” group epoch, for which AID is in use only for beacon frames, with AID assignment provided every 5-150 minutes. The automatic parameter update in such a slow epoch can potentially lower devices power consumption, which could be considered of particular importance for Internet of Things (IoT) use cases, at least in some scenarios. For example, avoiding extra signaling for IoT devices transmissions can lower power consumption. Such devices can be configured to operate only on single user (SU) transmissions, e.g., such that the AID does not need to be used in the uplink or downlink transmissions. As another possibility, it can be the case that the AID is only used in DL transmissions.

In the illustrated example, a default group epoch can also be configured, with anonymization every 100-2000 ms and AID assignment on the order of 2-5 minutes. The default group can change address and AID offset per a multiple of the beacon period. The assigned AID change can potentially protect against tracking from STAs associated to the same basic service set (BSS). The default group may change STA address, SN[TID] offsets and PN offset for the traffic, at least according to some embodiments.

Additionally, a “fast” group epoch can be configured in the illustrated scenario, with anonymization every 5-50 ms and AID assignment on the order of 30 s-2 minutes. In some embodiments, the STAs in this group can anonymize More Data, End of Service Period (EOSP), Power Management, and HT control fields.

Note that these example group epochs are not intended to be exhaustive or restricted, and that any number of different group epochs could also or alternatively be defined and used, each potentially with some or all operating parameters differing from the illustrated examples.

A WLAN transmitter may typically encrypt the payload data of an MPDU only once, at least according to some embodiments. Thus, it can be the case that the encrypted data payload does not change if the STA MAC address in the MAC header changes. It could potentially thus be possible for an eavesdropper to monitor the MPDU payloads to detect whether the same data payload is transmitted from a new address. In this case, the eavesdropper may be able to determine that the new address belongs to the same device as the old address. The tracked data payload could be transmitted in the downlink or the uplink. This mapping could thus potentially be used to track a STA. Accordingly, it may be the case that an address transition in which old data is not transmitted from the new address is a successful address switch for anonymization.

FIG. 12 illustrates aspects of an example scenario in which address switches occur with and without retransmission across the address switches, according to some embodiments. As shown, in the first and second address switches of the illustrated scenario, eavesdroppers may be able to map the old and new addresses to the same STA, e.g., by detecting retransmissions of the same MPDU (e.g., SN 130 across the first address switch and SN 220 across the second address switch). In the third address switch, no retransmissions occur after the address switch, and the address switch accomplishes the STA anonymization.

For scenarios with frequent address transitions, it may be acceptable to tolerate data payload retransmissions on new addresses, at least according to some embodiments. For example, if the address transitions are sufficiently frequent (e.g., every 100-500 ms, as one possibility; other ranges may be considered sufficiently frequent in other embodiments), enough non-trackable address transitions can potentially still occur to prevent effective tracking. While this approach may reduce the number of non-trackable address transitions, it may potentially be relatively simple to implement. In some scenarios, the STA and AP may agree on a maximum number of consecutive address switches with retransmitted data payload that is initially transmitted using the old address, e.g., to limit the amount of time without a non-trackable address transition.

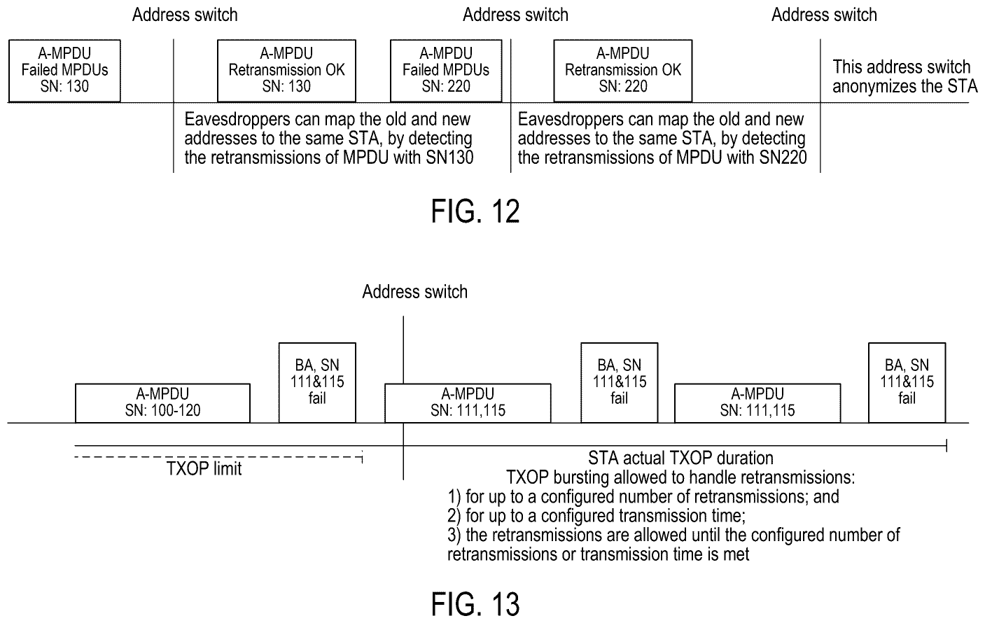

One possibility to mitigate the retransmission issue could include supporting continuing a TXOP until all frames are received, the retransmitted frames are discarded, or until a configured maximum TXOP continuation time has elapsed. Thus, the transmitter could potentially extend the TXOP over its nominal limit to retransmit MPDU payload using the old address when an address switch is imminent. The payload may be retransmitted in new PPDUs by using SIFS bursting, in some embodiments. The TXOP extension may be limited to ensure some fairness between devices; for instance, a scenario could occur in which the TXOP limit is 3 ms, but TXOP extension for retransmission could allow up to 10 ms TXOP duration, or up to 3 additional retransmissions. MPDUs that are not correctly received within the extended TXOP may be discarded. FIG. 13 illustrates aspects of an example scenario in which such a TXOP extension could occur, according to some embodiments.

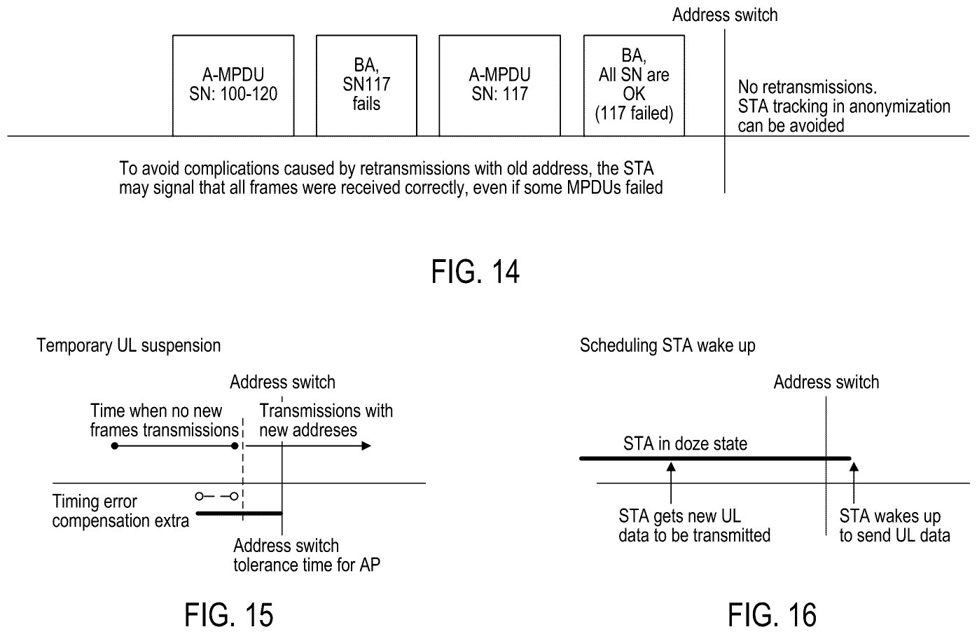

In some scenarios, a STA may tolerate some frame loss for certain streaming or real-time applications. For instance, a real-time application may have strict delay limits for frame transmission, the codec may tolerate some frame loss while keeping the stream in good quality, and/or the STA may be able to rely on higher level (e.g., TCP or Quic) retransmissions. A STA may be able to keep a record of frames for which transmission failed before an address switch, check the highest received SN and detect possible holes on smaller SNs, and record the total number of failed MPDUs that are missing at the address switch. In some cases, poor AP implementation may result in retransmissions of frames after an address switch that could take a long time. Accordingly, to mitigate the complexity of the address change, it could be the case that the STA is provided with internal logic to acknowledge one or more not-received MPDU(s) in order to avoid retransmissions after an address change. FIG. 14 illustrates aspects of an example scenario in which such false acknowledgement could occur, according to some embodiments.

Similarly, a STA could have internal logic to cancel or avoid uplink frame retransmissions after an address change. A STA can temporarily suspend UL MPDUs transmission in proximity to an address change, and start transmission with the new address once allowed to in accordance with the address change time, as one such possibility. FIG. 15 illustrates aspects of an example scenario in which such temporary UL transmission suspension could occur, according to some embodiments. If new data arrives when a STA is in a doze state (e.g., in proximity to an address change), the STA may wait to wake until it can use the new address, e.g., to minimize its power consumption. FIG. 16 illustrates aspects of an example scenario in which such dozing extension is performed, according to some embodiments. As another possible technique, in some cases, if a STA considers that the AP has no retransmissions expected, the STA may signal to the AP that it is unavailable or in power save just before the address switch time to avoid a situation in which the AP could have frames that need to be retransmitted to the STA across the address switch.

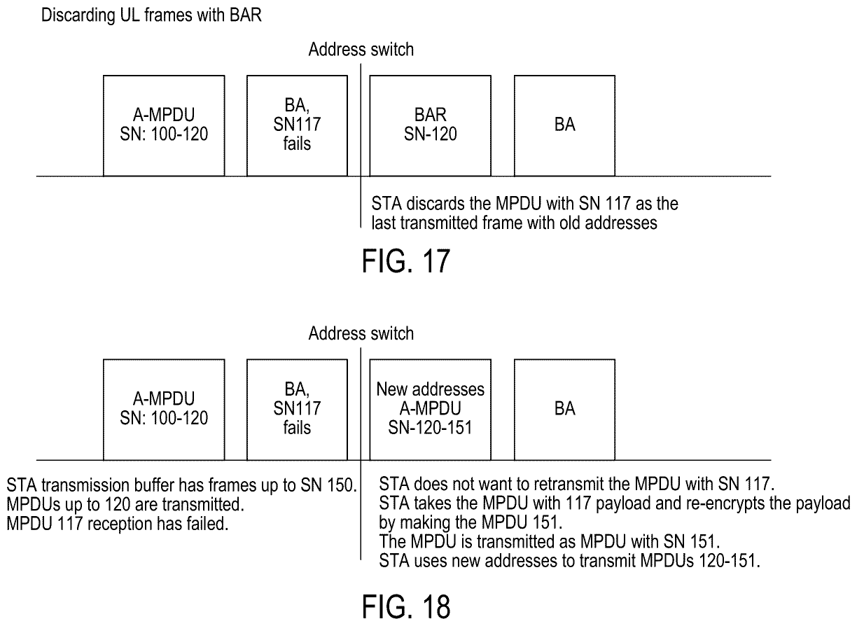

Another possible UL MPDU retransmission avoidance technique can include discarding UL frames with a block acknowledgement request (BAR). FIG. 17 illustrates aspects of an example scenario in which such an approach is used, according to some embodiments. In such an approach, a STA may determine to move the BA window forward and not discard failed UL MPDUs across an address switch. This operation may be performed for real-time applications that tolerate some frame loss, in some embodiments. The BAR frame may be transmitted as the last frame of the TXOP that uses the old address, e.g., to ensure that the STA that appears with the new address does not reveal itself by transmitting a BAR frame in the first TXOP after the address switch.

A STA may be able to create a new MPDU out of failed MPDUs, in some embodiments. FIG. 18 illustrates aspects of an example scenario in which such MPDU re-creation and new transmission is performed instead of retransmission, according to some embodiments. In this approach, the data frames' transmission order may change. The failed MPDUs can be created as new frames with higher SN values. The end receiver can still receive all frames, so it may be the case that this scheme does not suffer from frame loss. The transmitted application may have separate headers that allow the end receiver to arrange frames into playout order. For instance, MPDUs may have IP data with UDP and Real-time Protocol (RTP) data, and the receiver may use the RTP header timestamps to arrange the packets into playout order, as one possibility. The AP and STA may have an optional capability to enable retransmitted MPDUs re-creation as a new MPDU. The STA may change the DSCP value of the IP packet before it encrypts the packet again. This can cause the encrypted MPDU payload to be different. In the UL direction, the STA may have implementation specific logic to decide whether it creates a new MPDU out of MPDU(s) that require retransmission after an address change. It may be the case that the STA does not need to inform the AP if it makes such a new MPDU. This operation to create new MPDUs on the retransmitted MPDUs may be decided on QoS-level (e.g., for specific User Priority (UP) or Traffic ID (TID) values), in some instances. For example, for DL transmissions, the AP and STA may agree that some QoS levels (e.g., specific UPs or TIDs) may create new MPDUs from MPDUs that need retransmission. In such a case, any DL frame in such a UP or TID can be made into a new MPDU if it needs retransmission after an address change. The stream classification service (SCS) setting may configure the number of retransmitted frames that are allowed to be re-created as new MPDUs on a per address basis, in some embodiments. Additionally, or alternatively, the SCS setting may configure a TID to create new MPDUs for the MPDUs that need retransmission after an address change. This setting may generally allow the STA to describe the QoS characteristics of a stream. Thus, as one parameter of the SCS setup, the STA may configure that frames can be re-created as new MPDUs, if they need retransmission after an address change time.

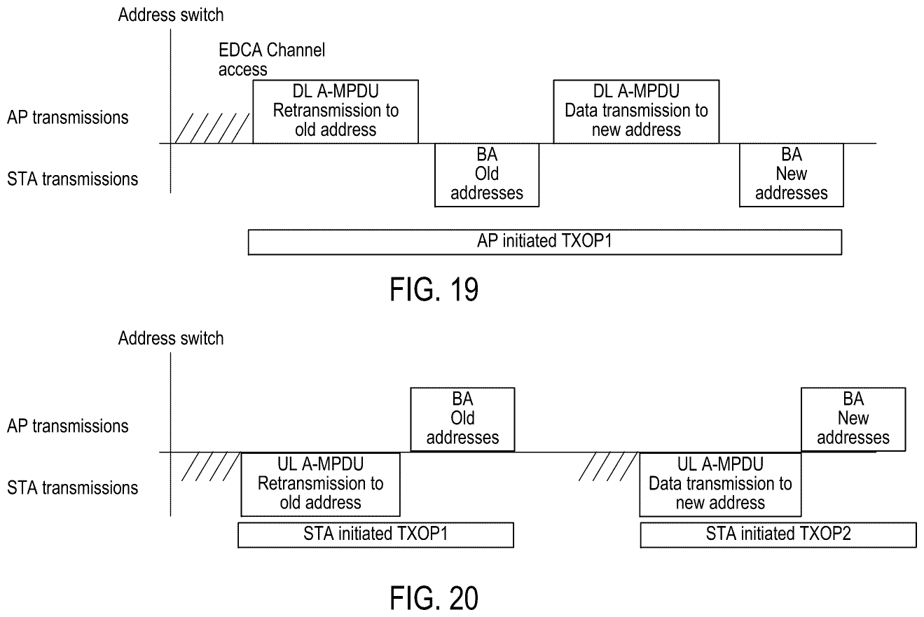

In some embodiments, the use of the old and new address across an address change can have different rules for UL and DL TXOPs. It may be the case that UL enhanced distributed channel access (EDCA) TXOPs are allowed to transmit UL frames only from a single address. Transmissions from multiple addresses in a TXOP can potentially be difficult to implement for EDCA, so using two addresses in the same TXOP could potentially reveal the STA in such a scenario. In contrast, it may be the case that DL TXOPs can transmit traffic to multiple STAs, and an AP may accordingly transmit traffic to the same STA using both its old address and its new address in the same TXOP across an address change. However, even in this case, it may be that an AP cannot simultaneously transmit traffic to the old and the new address of the same STA, as the STA may not be able to receive both transmissions. If both AP and STA addresses are anonymized in an address change, then it can be the case that frames are transmitted only to a single receiver in both UL and DL TXOPs, at least in some embodiments. FIG. 19 illustrates an example scenario in which an AP provides DL frames to a STA using both an old address and a new address across an address change during the same AP initiated TXOP, while FIG. 20 illustrates an example scenario in which a STA provides separate UL frames to an AP using an old address and then a new address across an address change during different STA initiated TXOPs.

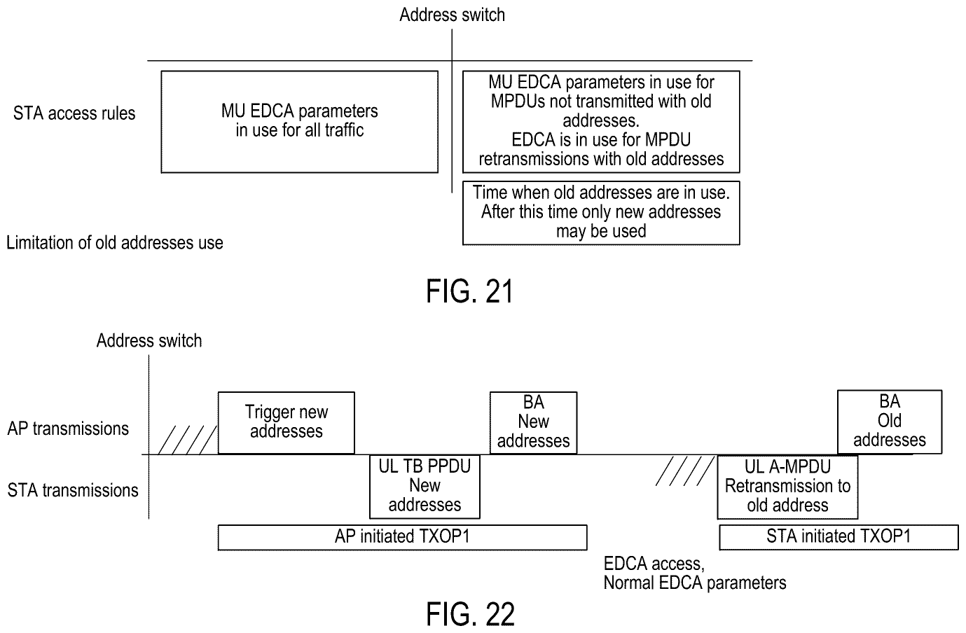

An AP may be able to use multi-user EDCA parameters to reduce EDCA transmissions from STAs from which UL transmissions are triggered. However, it can be the case that MU EDCA parameters are poor EDCA parameters that reduce EDCA transmission possibilities and allow traffic available to be transmitted as a response to a trigger frame, and in some cases MU EDCA may set EDCA completely off. A trigger frame can identify a STA by using an AID; the old and new address across an address change can accordingly use different AIDs. It can also be the case that a STA only transmits MPDUs with a single address as a response to a trigger frame. In some embodiments, an AP can signal in a protected (re)association response that the AP may not trigger STA frames from the old address after an address change. In these cases, the STA may retransmit the old addressed MPDUs by using EDCA and ignore MU EDCA parameters for these frames. FIGS. 21-22 illustrate aspects of example scenarios in which MU EDCA parameters are relaxed for MPDU retransmissions with old addresses during and/or within a certain time range of an address change.

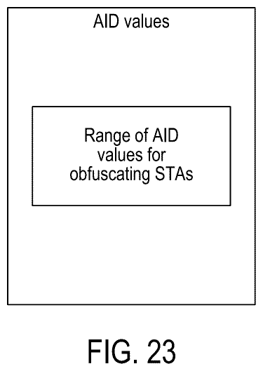

In some systems, AID, TID, SN, and PN have common multi-link device (MLD) level values on all links, while addresses are link specific. In 802.11bi, it can be the case that AID has a BSS specific offset; other MAC header fields (TID, SN, and PN) have a STA specific offset. As illustrated in FIG. 23, for AID obfuscation, a range of AID values (e.g., that is a subset of possible AID values) can be assigned for obfuscating STAs. For example, AID values 100-500 could be assigned to obfuscating STAs. It may be the case that obfuscating STAs use the same BSS specific AID offset, so AID collisions can be avoided. Thus, in this example, the obfuscated AID for a STA can be calculated as:

$${AID}_{Obfuscated} = 100 + ( {AID}_{Assigned} + Offset ) MOD 400$$

An associated STA may change its AID Assigned by using explicit individual obfuscation, in some embodiments.

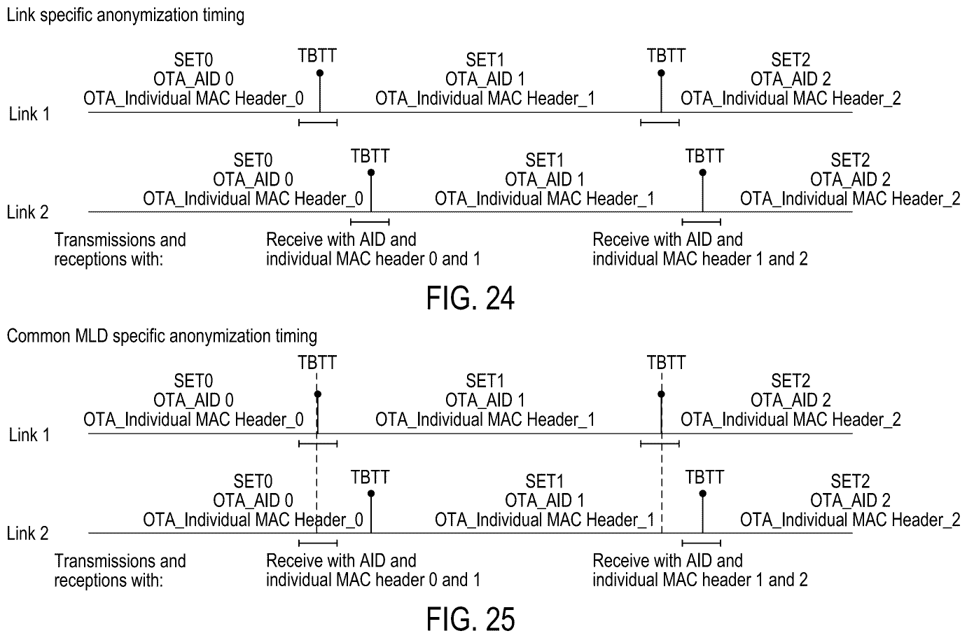

There may be multiple possibilities for the level at which device anonymization is performed, potentially including on MLD level or link level. Further, different aspects could be performed at different levels; for example, either or both of the anonymization timing or the offset parameters could be managed on either of the MLD level or the link level. For example, for anonymization timing, the offset change could be per link (e.g., the timing could be different for each link) or per MLD (e.g., all offsets could be changed at the same time). Similarly, for offset parameters, these could be defined per link or per MLD. FIG. 24 illustrates aspects of an example scenario in which link specific anonymization timing is used, while FIG. 25 illustrates aspects of an example scenario in which common MLD specific anonymization timing is used, according to various embodiments. Thus, for common MLD specific timing and MLD level offset parameters, the same offset can be applied on all links at the same time. For common MLD specific timing and link level offset parameters, all links can have different offsets which are all changed at the same time. For per link timing and link level offset parameters, each link anonymization can work independently and at its own time. For per link timing and MLD level offset parameters, the links could change to the same offset at different times. However, it should be noted that this last case could potentially lead to a device being trackable across an address change.

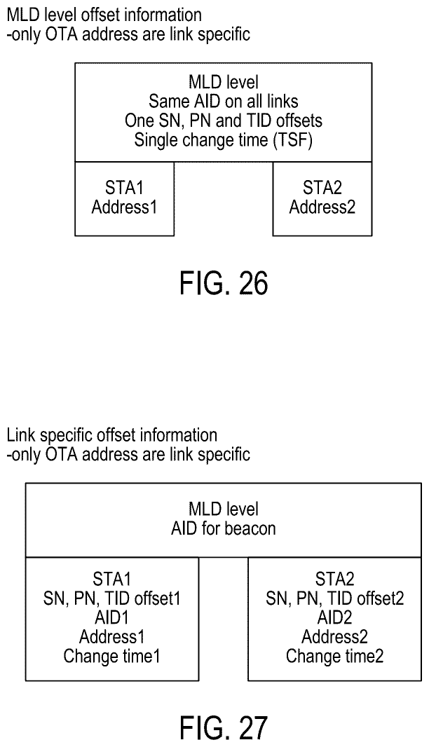

FIG. 26 illustrates further aspects of a possible MLD level offset approach, according to some embodiments. For such MLD level anonymization offset, the STA OTA address is link specific, while the other parameters use the same offset on all links. AID is the same in all links. The link specific AID value may be used in the TIM of the beacon frame, or a separate AID for the beacon may be used. Eavesdroppers could potentially detect the links in which a non-AP MLD operates by monitoring OTA SN, TID, and PN values in this approach.

FIG. 27 illustrates further aspects of a possible link level offset approach, according to some embodiments. For such link level anonymization offset, the AID, STA OTA address, SN, PN, and TID have link specific offsets. This approach may prevent eavesdroppers from detecting the links in which a non-AP MLD operates, because STAs do not have common field values for the different links, which may correspondingly provide better privacy than a MLD level offset approach, at least in some embodiments. However, a STA needs to maintain the different link specific offsets, and, before transmission, apply (e.g., XOR) the link specific offset, which can potentially introduce additional implementation complexity.

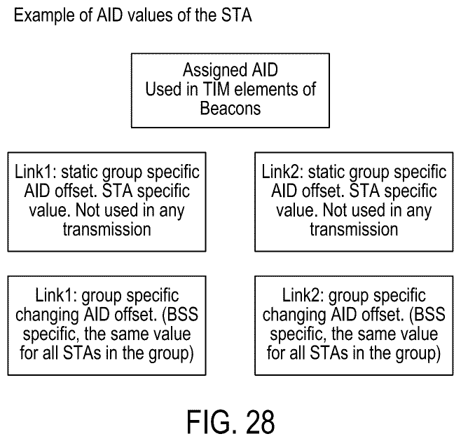

FIG. 28 provides further possible details for a link specific anonymization approach, according to some embodiments. As shown, a STA can have an assigned AID value, which is used in the beacon; using the assigned AID value in the beacon can help keep the beacon frame relatively short. Each group epoch can have a link specific AID in use. The STA in the group that operates in the link may have a group specific AID value for the group, and this value may be within the group specific AID range. The group specific AID value can be anonymized according to the link and group specific AID offset. The AID offset can be changed periodically at the same time when the group specific addresses are changed. An AP may periodically assign new values to assigned AID and group specific static offsets. The changes to these AID values can help protect against associated STAs tracking. A STA can also request new AID values assignment; the AP can respond with new AID values and the time when the values are taken into use. The AP can also potentially signal unsolicited new assigned AID values and the time when the new assigned AID values are taken into use, at least according to some embodiments.

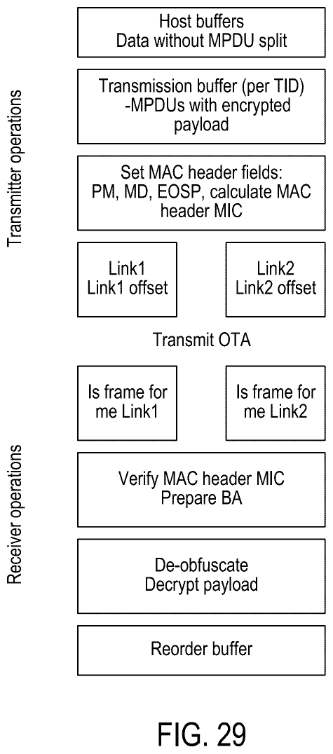

FIG. 29 illustrates a summary of link and MLD level offset applications in transmitter and receiver operations, according to some embodiments. As shown, frame anonymization can be the last operation before sending a frame over the air. In the illustrated example, the Address 1 and Address 2 are changed to link specific addresses. For such link specific offset use, it can be the case that per link offset calculation, per link offset storing, and per link offset updating are required. In some instances, the same data payload transmitted in different links can be trackable with such an approach; accordingly, it may be the case that a STA determines to transmit a given data payload only in a single link. For MLD specific offset, it can be the case that a single offset calculation can be performed, with use of the single offset for all links (except that addresses can be link specific), and with a single offset update needed (e.g., all links are updated at the same time), in some embodiments.

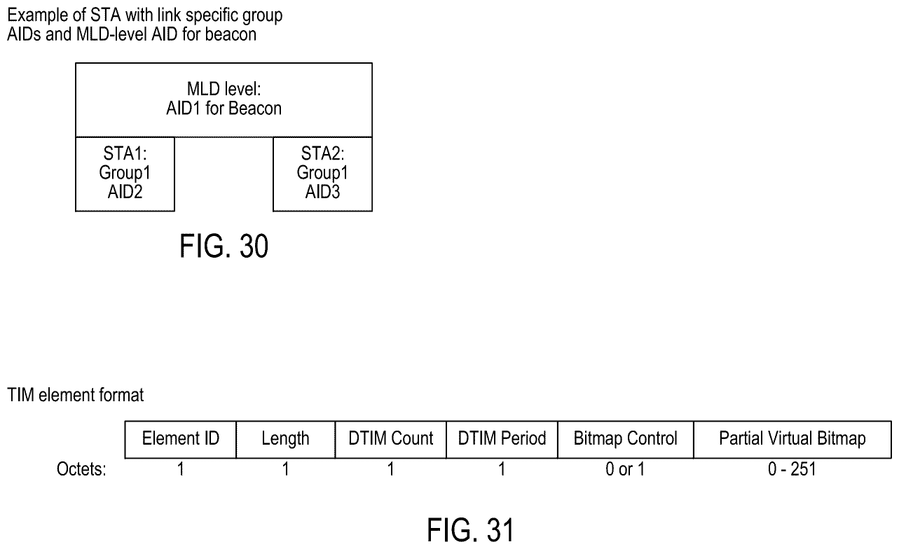

The TIM element in a beacon frame can signal that buffered traffic is present for power saving STAs. The TIM element can potentially be large, e.g., if an AP operates many group epochs, with each group epoch having a different AID range. To reduce TIM element size, there could be a group specific AID (for data transmission OTA) and beacon specific AID (for buffered traffic signaling). FIG. 30 illustrates aspects of an example STA with such separate link specific group AIDs and MLD level AID for beacon, while FIG. 31 illustrates aspects of an example TIM element format, which can include a partial virtual bitmap field for buffered traffic signaling, according to some embodiments.

The data transmission specific AID can be assigned by the AP quickly, for instance in a unicast or broadcast management frame, or a trigger frame, in some embodiments. The AID in the beacon can be selected to reduce TIM element size, by keeping the AID value of the STA used in the beacon the same, with the AP and STA calculating the offset to anonymize the TIM bits. The TIM offset can be a bit pattern that is added to selected AID values of the TIM element. For example:

$$TIM [ AID ] = \{ \begin{matrix}1 , & if STA is in PS and AP has buffered traffic to STA \\ 0 , & in all other cases\end{matrix}$$

$$OTA\_TIM [ AID ] = TIM [ AID ] XOR {TIM}_{offset}$$

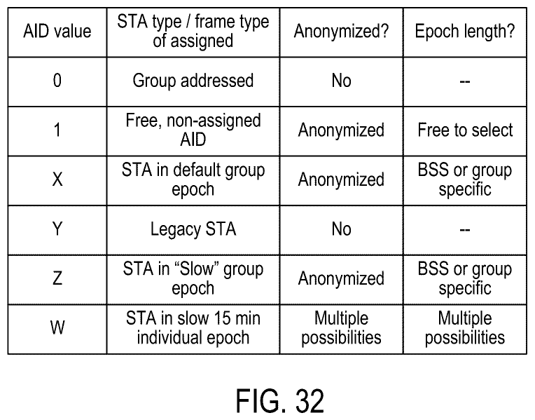

There may be multiple options for TIM anonymization/offset calculation, according to various embodiments. The TIM offset can be BSS specific and changed with every beacon, as one possibility. This may provide good TIM anonymization, but the anonymization value needs to be separately calculated per beacon. As another possibility, the AP can change the TIM offset at group anonymization times. In this case, a STA may perform a single calculation to determine the TIM offset and AID offset. The TIM offset change may take several beacon periods, in this case, at least in some embodiments. The BSS specific TIM offset approach may simplify AP operation, as the AP may need to calculate only a single offset. For example, in contrast, STA specific TIM offsets could potentially require a more computation expensive separate calculation per STA. The AP may be able to randomize unassigned AIDs frequently or according to any pseudo-random rule. The AP may potentially combine multiple anonymization mechanisms; in principle TIM anonymization could include a STA specific anonymization rule. FIG. 32 is a table illustrating possible example TIM AID handling aspects for various STA and frame types for an AP that supports anonymization using one or more group and/or individual epochs, according to some embodiments. As shown, the illustrated example includes possible use cases for STAs that also support such anonymization and are operating in various group or individual epochs, as well as potentially for legacy STAs that do not support such anonymization and for group addressed frames, for which it may be the case that AID anonymization is not performed.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
by a first wireless device:
receiving, from an access point (AP) wireless device, an indication that multiple group epochs are supported by the AP wireless device;
transmitting, to the AP wireless device, an epoch request;
receiving, from the AP wireless device, epoch configuration information in response to the epoch request; and
performing, in accordance with the epoch configuration information, communication with the AP wireless device using wireless device identification obfuscation.

2. The method of claim 1, wherein the method further comprises:
transmitting, to the AP wireless device, an association request that comprises the epoch request, wherein the epoch request comprises a group epoch request that requests that the first wireless device be assigned to a default group epoch; and
receiving, from the AP wireless device, an association response that comprises epoch configuration information for the default group epoch.

3. The method of claim 1, wherein the method further comprises:
receiving, from the AP wireless device, an indication that individual epoch support is available from the AP wireless device;
transmitting, to the AP wireless device, an individual epoch setup request that requests that the first wireless device be assigned to an individual epoch; and
receiving, from the AP wireless device, an individual epoch setup response that includes epoch configuration information for the individual epoch.

4. The method of claim 1, wherein the method further comprises:
receiving, from the AP wireless device, non-default group epoch discovery information;
transmitting, to the AP wireless device, a non-default group epoch setup request that requests that the first wireless device be assigned to a non-default group epoch; and
receiving, from the AP wireless device, a non-default group epoch setup response that includes epoch configuration information for the non-default group epoch.

5. The method of claim 1, wherein the epoch configuration information comprises at least one of:
a basic service set (BSS) specific offset configured for use in obfuscating an association identifier (AID) for the first wireless device;
a station specific offset configured for use in obfuscating one or more media access control (MAC) header fields for the first wireless device; or
a period of time between successive address switches for the first wireless device.

6. The method of claim 1, wherein the method further comprises:
extending a transmit opportunity (TXOP) beyond a TXOP limit to retransmit a frame with address continuity during an address switch window for an epoch for the first wireless device.

7. The method of claim 1, wherein the method further comprises:
transmitting a frame acknowledgement for a frame that was not received based at least in part on address switch window timing for an epoch for the first wireless device.

8. The method of claim 1, wherein the method further comprises:
temporarily suspending uplink frame transmission based at least in part on address switch window timing for an epoch for the first wireless device.

9. The method of claim 1, wherein the method further comprises:
transmitting a block acknowledgement request frame to move a block acknowledgement window forward based at least in part on address switch window timing for an epoch for the first wireless device.

10. The method of claim 1, wherein the method further comprises:
creating one or more new frames for transmission after an address switch for an epoch for the first wireless device, wherein the one or more new frames are created using one or more failed frames from before the address switch for the epoch for the first wireless device.

11. The method of claim 1, wherein the first wireless device is a multi-link device (MLD), wherein the AP wireless device is also a MLD, wherein the method further comprises:
establishing multiple wireless links between the first wireless device and the AP wireless device,
wherein the epoch configuration information comprises:
per-wireless link offset information for performing wireless device identification obfuscation and per-link anonymization timing for the multiple wireless links;
per-wireless link offset information for performing wireless device identification obfuscation and MLD level anonymization timing for the multiple wireless links; or
MLD level offset information for performing wireless device identification obfuscation and MLD level anonymization timing for the multiple wireless links.

12. An apparatus, comprising processing circuitry and memory configured to cause the processing circuitry to:
receive an indication that an access point (AP) wireless device supports one or more of individual epochs or multiple group epochs;
generate signaling comprising an individual epoch request or a group epoch request based at least in part on the indication that the AP wireless device supports one or more of individual epochs or multiple group epochs;
receive epoch configuration information that includes at least offset information for identity masking and offset change timing information for an epoch; and
generate one or more frames configured for wireless transmission using the offset information for identity masking.

13. The apparatus of claim 12, wherein the memory is further configured to cause the processing circuitry to:
receive group epoch discovery information indicating that the AP wireless device supports multiple group epochs with different anonymization periodicities.

14. The apparatus of claim 12, wherein the epoch configuration information comprises:
per-wireless link offset information and per-wireless link offset change timing information for multiple wireless links;
per-wireless link offset information and multi-link device (MLD) level offset change timing information for multiple wireless links; or
MLD level offset information and MLD level offset change timing information for multiple wireless links.

15. The apparatus of claim 12,
wherein the epoch configuration information further comprises traffic indication map (TIM) offset information, wherein the TIM offset information is changed at one or more of:
beacon intervals for the AP wireless device; or
offset change timing for the epoch.

16. An access point (AP) wireless device, comprising:
one or more antennas;
one or more radios operably coupled to the one or more antennas; and
a processor operably coupled to the one or more radios;
wherein the AP wireless device is configured to:
send, to a non-AP wireless device, an indication that multiple group epochs are supported by the AP wireless device;
receive, from the non-AP wireless device, an epoch request;
send, to the non-AP wireless device, epoch configuration information in response to the epoch request; and
perform, in accordance with the epoch configuration information, communication with the non-AP wireless device using wireless device identification obfuscation.

17. The AP wireless device of claim 16,
wherein the epoch configuration information comprises at least one of:
a basic service set (BSS) specific offset for use in obfuscating an association identifier (AID) for the non-AP wireless device;
a station specific offset for use in obfuscating one or more media access control (MAC) header fields for the non-AP wireless device; or
an epoch period length.

18. The AP wireless device of claim 16,
wherein the multiple group epochs include group epochs with different anonymization periodicity.

19. The AP wireless device of claim 16,
wherein the epoch configuration information comprises traffic indication map (TIM) offset information for the non-AP wireless device, wherein a TIM offset for the non-AP wireless device is changed at beacon intervals.

20. The AP wireless device of claim 16,
wherein the epoch configuration information comprises traffic indication map (TIM) offset information for the non-AP wireless device, wherein a TIM offset for the non-AP wireless device is changed at group epoch anonymization times for the non-AP wireless device.
